(19) United States
(12) Patent Application Publication
(10) Pub. No.: US 2020/0006773 A1
(43) Pub. Date: Jan. 2, 2020

(54) ORTHOPHOSPHATE ELECTRODES FOR RECHARGEABLE BATTERIES

(71) Applicant: QATAR FOUNDATION FOR EDUCATION, SCIENCE AND COMMUNITY DEVELOPMENT, DOHA (QA)

(72) Inventors: RACHID ESSEHLI, DOHA (QA); ILIAS BELHAROUAK, DOHA (QA); HAMDI BEN YAHIA, DOHA (QA); ALI ABOUIMRANE, DOHA (QA)

(73) Assignee: QATAR FOUNDATION FOR EDUCATION, SCIENCE AND COMMUNITY DEVELOPMENT, DOHA (QA)

(21) Appl. No.: 15/777,607

(22) PCT Filed: Nov. 15, 2016
(86) PCT No.: PCT/QA2016/050008

§ 371 Date: May 18, 2018

Related U.S. Application Data
(60) Provisional application No. 62/257,679, filed on Nov. 19, 2015.

(51) Int. Cl. H01M 4/58; C01B 25/45; H01M 4/136; H01M 4/62

(52) U.S. Cl. CPC H01M 4/5825; H01M 4/625; H01M 4/136; C01B 25/45

(57) ABSTRACT

The orthophosphate electrodes for rechargeable batteries include an anode and a cathode, each formed from an orthophosphate material, for use in a conventional electrolytic cell-type rechargeable battery. The orthophosphate anode is an anode formed from an orthophosphate material having the formula A₂T₂B(PO₄)3, and the orthophosphate cathode is a cathode formed from an orthophosphate material having the formula A₃T₂B(PO₄)₃, where A represents an alkali metal and T and B each represent a transition metal. The alkali metal may be lithium (Li) sodium (Na), potassium (K), rubidium (Rb), cesium (Cs), monovalent cations thereof, or combinations thereof and each transition metal may be titanium (Ti), vanadium (V), chromium (Cr), manganese (Mn), iron (Fe), cobalt (Co), nickel (Ni), copper (Cu), or combinations thereof. The transition metal may be a divalent or trivalent transition metal

### TECHNICAL FIELD

The present invention relates to electrochemical cells and batteries, and particularly to orthophosphate electrodes for rechargeable batteries.

### BACKGROUND ART

A rechargeable battery (also referred to as a “secondary battery”) is a type of electrical battery that can be charged, discharged into a load, and recharged many times, as opposed to a non-rechargeable or “primary” battery, which is supplied fully charged and discarded once discharged. A rechargeable battery, like a primary battery, is composed of one or more electrochemical cells. Rechargeable batteries are also referred to as “accumulator” batteries, because the rechargeable battery accumulates and stores energy through a reversible electrochemical reaction.

FIGS. 2A and 2B schematically illustrate a basic rechargeable battery, formed from a single electrochemical cell 10, as the battery is being charged (FIG. 2A) and discharged into a load (FIG. 2B). As shown in FIG. 2A, during the process of charging, a voltage is applied across anode 16 and cathode 18 by a charger 12. Anode 16 and cathode 18 are immersed in an electrolytic solution 20 and, as shown, anode 16 undergoes a reduction reaction while cathode 18 undergoes an oxidation reaction. Cations in the electrolytic solution 20 flow to the anode 16 and anions flow to the cathode 18. In FIG. 2B, where the rechargeable battery is shown being discharged into an external load 14, the reactions are reversed; i.e., anode 16 undergoes oxidation and cathode 18 is reduced, with cations in electrolytic solution 20 flowing to cathode 18 and anions flowing to anode 16.

Rechargeable batteries are produced in many different shapes and sizes, ranging from button cells to megawatt systems connected to stabilize an electrical distribution network. Several different combinations of electrode materials and electrolytes are used, including lead-acid, nickel cadmium (NiCad), nickel metal hydride (NiMH), lithium ion (Li-ion), and lithium ion polymer (Li-ion polymer). With lithium, in particular, potentially having a limited supply, there is great interest in finding other materials, which are more plentiful and which could be used as electrode materials for rechargeable batteries.

Thus, orthophosphate electrodes for rechargeable batteries solving the aforementioned problems are desired.

### DISCLOSURE OF INVENTION

The orthophosphate electrodes for rechargeable batteries include an anode and a cathode, each formed from an orthophosphate material, for use in a conventional electrolytic cell-type rechargeable battery. The orthophosphate anode is an anode formed from an orthophosphate material having the formula A₂T₂B(PO₄)₃, and the orthophosphate cathode is a cathode formed from an orthophosphate material having the formula A₃T₂B(PO₄)₃, where A represents an alkali metal and T and B each represent a transition metal. The alkali metal may be lithium (Li), sodium (Na), potassium (K), rubidium (Rb), cesium (Cs), monovalent cations thereof, or combinations thereof, and each transition metal may be a divalent or trivalent transition metal. Each transition metal can be titanium (Ti), vanadium (V), chromium (Cr), manganese (Mn), iron (Fe), cobalt (Co), nickel (Ni), copper (Cu), or combinations thereof.

The orthophosphate anode and the orthophosphate cathode may include only the orthophosphate materials described above, or each may be formed as a composite of the respective orthophosphate material and carbon. The carbon, which may be in the form of carbon nanotubes, graphene, graphene oxide or the like, including combinations thereof, may be added to the orthophosphate materials after the material preparation or may generated during the material synthesis.

These and other features of the present invention will become readily apparent upon further review of the following specification and drawings.

### BRIEF DESCRIPTION OF THE DRAWINGS

FIG. 1 is a graph showing magnetic susceptibility χ as a function of temperature T and a corresponding χ⁻¹ vs. T plot for an exemplary α-Na₂Ni₂Fe(PO₄)₃ orthophosphate anode for rechargeable batteries according to the present invention, measured with an applied field of 100 Oe.

FIG. 2A schematically illustrates a conventional prior art rechargeable battery being charged.

FIG. 2B schematically illustrates the conventional prior art rechargeable battery being discharged.

FIG. 3 is a graph showing charge-discharge curves of the exemplary α-Na₂Ni₂Fe(PO₄)₃ orthophosphate anode for rechargeable batteries at a current density of 50 mAg⁻¹, where the inset corresponds to a zoom of the first discharge curve in the capacity area 0 to 60 mA hg⁻¹.

FIG. 4 is a graph showing performance of the exemplary α-Na₂Ni₂Fe(PO₄)₃ orthophosphate anode in the voltage range 0.03-3 V vs. Na⁺/Na at 20° C.

FIG. 5 is a graph showing galvanostatic charge/discharge profiles of an exemplary Na₃Ni₂Fe(PO₄)₃ orthophosphate cathode for rechargeable batteries according to the present invention, in an Na-ion cell at 5 mA g⁻¹ current rate, in the voltage range 1.8-4.5 V.

Similar reference characters denote corresponding features consistently throughout the attached drawings.

### BEST MODES FOR CARRYING OUT THE INVENTION

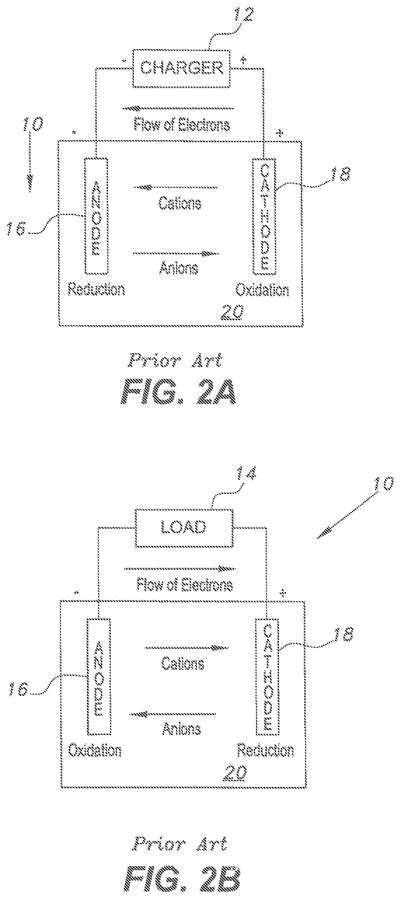

The orthophosphate electrodes for rechargeable batteries include an anode and a cathode, each formed from an orthophosphate material, for use in a conventional electrolytic cell-type rechargeable battery, such as electrochemical cell 10 of FIGS. 2A and 2B. The orthophosphate anode is an anode formed from an orthophosphate material having the formula A₂T₂B(PO₄)₃, and the orthophosphate cathode is a cathode formed from an orthophosphate material having the formula A₃T₂B(PO₄)₃, where A represents an alkali metal and T and B each represent a transition metal. The alkali metal may be lithium (Li), sodium (Na), potassium (K), rubidium (Rb), cesium (Cs), monovalent cations thereof, and combinations thereof, and each transition metal may be a divalent or trivalent transition metal, including titanium (Ti), vanadium (V), chromium (Cr), manganese (Mn), iron (Fe), cobalt (Co), nickel (Ni), copper (Cu), and combinations thereof. The orthophosphate anode and the orthophosphate cathode may include only the orthophosphate materials described above, or each may be formed as a composite of the respective orthophosphate material and carbon. The carbon, which may be in the form of carbon nanotubes, graphene, graphene oxide or the like, including combinations thereof, may be added to the orthophosphate materials after the material preparation or may generated during the material synthesis.

In one example, α-Na₂Ni₂Fe(PO₄)₃ was synthesized by solid state reaction from stoichiometric mixtures of Na₂CO₃, Ni(NO₃)₂.6H₂O, Fe(NO₃)₃.9H₂O, and NH₄H₂PO₄. The starting materials were ground in an agate mortar, put into a platinum crucible and heated at 200° C. for 6 hours and at 500° C. for 24 hours in air in order to release H₂O, NH₃, and CO₂. The resulting powder was then ground and heated at 850° C. for 48 hours. The progress of the reactions was followed by powder X-ray diffraction (PXRD), and the powder sample was found to be pure. It should be noted that thermal treatment above 850° C. would induce an irreversible phase transition from α- to β-Na₂Ni₂Fe(PO₄)₃.

Both Raman spectroscopy and Mössbauer spectroscopy were used to confirm the synthesis. Magnetic susceptibility measurements of the α-Na₂Ni₂Fe(PO₄)₃ were carried out using a vibrating sample magnetometer (VSM), and the susceptibility was recorded in the zero field cooled (ZFC) and field cooled (FC) modes in a temperature range of 2 K to 350 K, with an applied external field of 100 Oe. For electrochemical cycling, all electrochemical tests were made on half-cells in a thermostatic bath maintained at 25° C. The electrodes were made from a mixture of α-Na₂Ni₂Fe(PO₄)₃ powder (active material), super-P carbon (conductive additive), and polyvinylidene difluoride (PVDF) as a binder, in a weight ratio of 80:15:5. This mixture was compressed into sheets, cut into 8 mm diameter discs, loaded onto a Cu foil, and dried at 100° C. overnight. α-Na₂Ni₂Fe(PO₄)₃/NaPF₆.BC-DMC/Na coin-type cells were assembled in an argon-filled glove box. The room-temperature electrochemical performances were evaluated by galvanostatic charge/discharge cycling at different current rates, in the voltage range 0.03-3.0 V vs. Na⁺/Na.

Na₃Ni₂Fe(PO₄)₃ was prepared by discharging the α-Na₂Ni₂Fe(PO₄)₃/NaPF₆.EC-DMC/Na coin-type cell down to 1 V. The Na₃Ni₂Fe(PO₄)₃ electrode was then washed several times with EC, dried, and used as a positive electrode. Galvanostatic charge/discharge cycling was performed at a rate of 5 mA g⁻¹ in the voltage range 1.8-4.5 V vs. Na⁺/Na.

As noted above, the α-Na₂Ni₂Fe(PO₄)₃ was synthesized by a solid state reaction route. However, it should be understood that orthophosphate electrode materials may be produced by any desired method, such as a sol-gel method, a solvothermal technique, solid state reaction, ionothermal methods, or electrochemical methods involving the insertion of alkaline ions or by the addition of a reducing agent, such as NaI.

In the α-Na₂Ni₂Fe(PO₄)₃ example, the structure was determined based on a stuffed α-CrPO₄-type structural model. Sodium atoms are located within the 3D-framework of octahedra and tetrahedra sharing corners and/or edges with channels along [100] and [010]. The ⁵⁷Fe Mössbauer spectrum indicates that Fe³⁺ is distributed over two crystallographic sites, implying the presence of an Ni²⁺/Fe³⁺ statistical disorder.

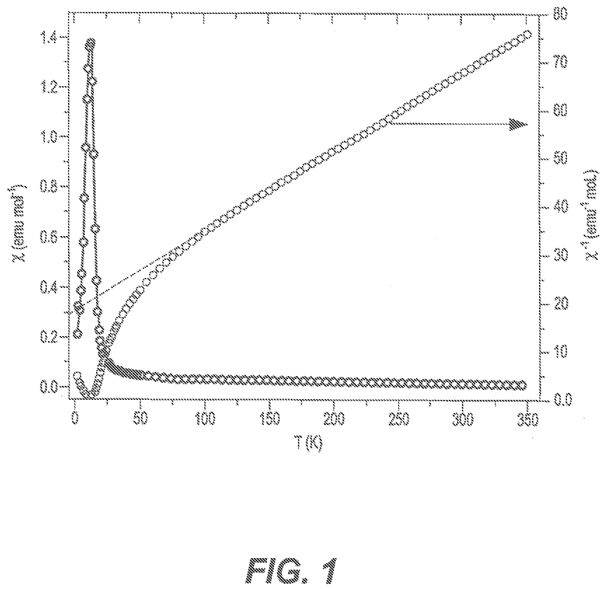

The magnetic susceptibility χ vs. T and the corresponding χ⁻¹ vs. T for α-Na₂Ni₂Fe(PO₄)₃ measured under 100 Oe and associated with zero-field-cooling magnetization (MZFC) arc shown in the graph of FIG. 1. The χ⁻¹ vs. T plot reveals that α-Na₂Ni₂Fe(PO₄)₃ exhibits a paramagnetic behavior in the temperature range 100-350 K. Susceptibility above 100 K follows a Curie-Weiss law with θ=−114.3 K. The negative θ indicates that the predominant spin exchange interactions are antiferromagnetic (AFM). The effective magnetic moment μ_{eff} calculated from the Curie constant 7.14 μ_{B} is in agreement with the effective moment of 7.01 μ_{B} expected for one high-spin Fe³⁺ (S=5/2) and two Ni²⁺ (S=1) atoms.

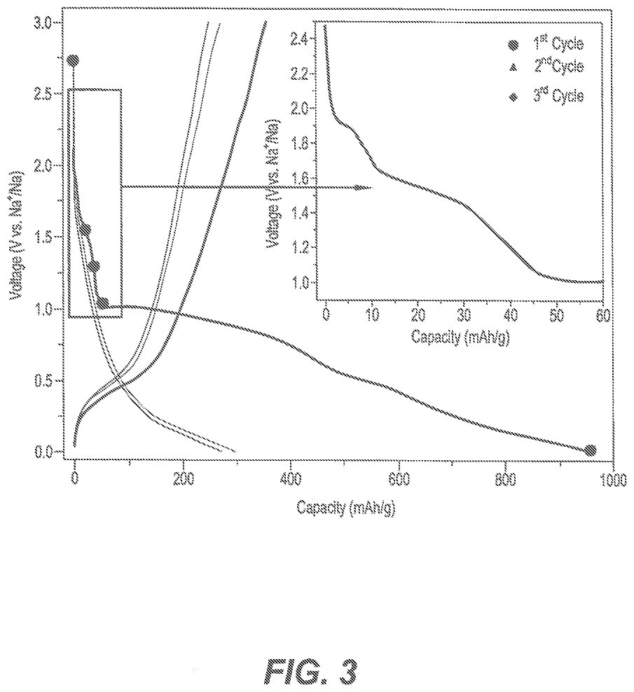

With regard to the use of α-Na₂Ni₂Fe(PO₄)₃ as an anode for sodium cells. FIG. 3 shows the initial charge/discharge cycle of an α-Na₂Ni₂Fe(PO₄)₃/NaPF₆.EC-DMC/Na half-cell between 0.03 and 3.0 V at a 50 mA g⁻¹ current density. The material undergoes an intercalation/conversion reaction in which the first discharge capacity of 960 mA hg⁻¹ corresponds to the reaction of more than seven sodium atoms. This capacity is much higher than the theoretical value 371 mA h g⁻¹ expected for the reduction of one Fe³⁺ to Fe⁰ and two Ni²⁺ to Ni⁰.

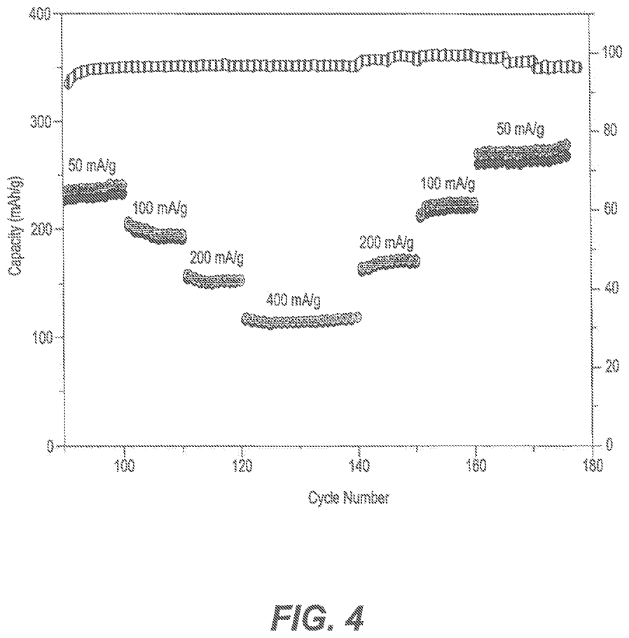

The first discharge curve signals an interesting behavior corresponding to the appearance of three pseudo-plateaus. The first one, observed between 2.75 and 1 V, corresponds to the reduction of Fe³⁺ to Fe²⁺, since the obtained discharge capacity of 53.5 mA h g⁻¹ corresponds to the intercalation of one sodium atom. Such a plateau has been often observed in iron phosphates, such as NaMnFe₂(PO₄)₃. The two additional plateaus, observed between 1 and 0.5 V, and between 0.5 and 0.03 V, correspond to the Fe^{2+/0}, Ni^{2+/0} redox couples, and most probably to the reduction of the electrolyte and/or the formation of solid electrolyte interface (SEI), respectively. It should be noted that the reduction of M²⁺ to M⁰ has been previously observed in oxyphosphates M_{0.5}TiOPO₄ (M:Ni, Co and Fe). FIG. 4 shows the rate capability of α-Na₂Ni₂Fe(PO₄)₃. Under the current rates of 50, 100, 200, and 400 mA g⁻¹, reversible capacities of 238, 196, 153, and 115 mA h g⁻¹ were obtained, respectively.

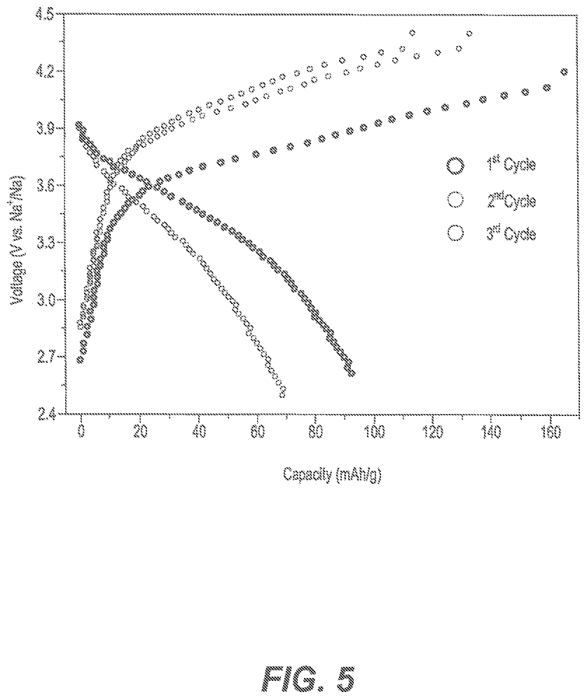

As noted above, upon the intercalation of one sodium atom into α-Na₂Ni₂Fe(PO₄)₃ a new phase α-Na₃Ni₂Fe(PO₄)₃ was formed. The electrochemically as-prepared material was then evaluated as a cathode by a galvanostatic charge/discharge cycling at a 5 mA g⁻¹ current rate in the voltage range 1.8-4.5 V vs. Na⁺/Na, as shown in FIG. 5. During the first charge, Na₃Ni₂Fe(PO₄)₃ delivers a capacity of 160 mA h g⁻¹, in good agreement with the theoretical capacity expected from the extraction of three sodium atoms and corresponding to the oxidation of one Fe²⁺ to Fe³⁺ and two Ni²⁺ to Ni³⁺. During the first discharge, Na₃Ni₂Fe(PO₄)₃ delivers a capacity of 92 mA h g⁻¹, which is similar to the capacities reported for Na₂Fe₃₋ₓMnₓ(PO₄)₃ (93 mA h g⁻¹) and Na₂Mn₂Fe(PO₄)₃ (60 mA h g⁻¹) crystallizing with the allaudite-type structure. It should be noted that the electrochemical activity of Na₃Ni₂Fe(PO₄)₃, centered at 3.59 V vs. Na⁺/Na, is different from the redox potentials observed in NaFePO₄ (2.7 V), Na₂FeP₂O₇ (3 V), and Na₄Fe₃(PO₄)₂(P₂O₇) (3.2 V), but close to the one observed in Na₄Ni₃(PO₄)₂(P₂O₇) (3.75 V). This confirms that the redox potential is very sensitive to the crystal structure and the coordination of the transition metal atoms.

It is to be understood that the present invention is not limited to the embodiments described above, but encompasses any and all embodiments within the scope of the following claims.

We claim:

1. An orthophosphate anode for rechargeable batteries, comprising an anode formed from an orthophosphate material having the formula A₂T₂B(PO₄)₃, where A represents an alkali metal and T and B represent different transition metals.

2. The orthophosphate anode for rechargeable batteries as recited in claim 1, wherein the alkali metal A comprises at least one alkali metal selected from the group consisting of lithium (Li), sodium (Na), potassium (K), rubidium (Rb), cesium (Cs), and monovalent cations thereof.

3. The orthophosphate anode for rechargeable batteries as recited in claim 2, wherein the transition metal T comprises at least one transition metal selected from the group consisting of titanium (Ti), vanadium (V), chromium (Cr), manganese (Mn), iron (Fe), cobalt (Co), nickel (Ni), and copper (Cu).

4. The orthophosphate anode for rechargeable batteries as recited in claim 3, wherein the transition metal B comprises at least one transition metal selected from the group consisting of titanium (Ti), vanadium (V), chromium (Cr), manganese (Mn), iron (Fe), cobalt (Co), nickel (Ni), and copper (Cu).

5. The orthophosphate anode for rechargeable batteries as recited in claim 4, wherein the anode further comprises a form of carbon.

6. The orthophosphate anode for rechargeable batteries as recited in claim 5, wherein the form of carbon comprises at least one form of carbon selected from the group consisting of carbon nanotubes, graphene, and graphene oxide.

7. An orthophosphate cathode for rechargeable batteries, comprising a cathode formed from an orthophosphate material having the formula A₃T₂B(PO₄)₃, wherein A represents an alkali metal and T and B represent different transition metals.

8. The orthophosphate cathode for rechargeable batteries as recited in claim 7, wherein the alkali metal A comprises at least one alkali metal selected from the group consisting of lithium (Li), sodium (Na), potassium (K), rubidium (Rb), cesium (Cs), and monovalent cations thereof.

9. The orthophosphate cathode for rechargeable batteries as recited in claim 8, wherein the transition metal T comprises at least one transition metal selected from the group consisting of titanium (Ti), vanadium (V), chromium (Cr), manganese (Mn), iron (Fe), cobalt (Co), nickel (Ni), and copper (Cu).

10. The orthophosphate cathode for rechargeable batteries as recited in claim 9, wherein the transition metal B comprises at least one transition metal selected from the group consisting of titanium (Ti), vanadium (V), chromium (Cr), manganese (Mn), iron (Fe), cobalt (Co), nickel (Ni), and copper (Cu).

11. The orthophosphate cathode for rechargeable batteries as recited in claim 10, wherein the cathode further comprises a form of carbon.

12. The orthophosphate cathode for rechargeable batteries as recited in claim 11, wherein the form of carbon comprises at least one form of carbon selected from the group consisting of carbon nanotubes, graphene, and graphene oxide.

13. A rechargeable battery, comprising:
an electrochemical cell containing an electrolytic solution;
an orthophosphate cathode immersed in the electrolytic solution, the orthophosphate cathode being an electrode formed from an orthophosphate having the formula A₃T₂B(PO₄)₃, where A represents an alkali metal and T and B represent different transition metals; and
an orthophosphate anode immersed in the electrolytic solution, the orthophosphate anode being an electrode formed from an orthophosphate having the formula D₂E₂F(PO₄)₂, where D represents an alkali metal and E and F represent different transition metals.

14. The rechargeable battery as recited in claim 13, wherein the alkali metals each comprise at least one alkali metal selected from the group consisting of lithium (Li), sodium (Na), potassium (K), rubidium (Rb), cesium (Cs), and monovalent cations thereof.

15. The rechargeable battery as recited in claim 14, wherein the transition metals each comprise at least one transition metal selected from the group consisting of titanium (Ti), vanadium (V), chromium (Cr), manganese (Mn), iron (Fe), cobalt (Co), nickel (Ni), and copper (Cu).

16. The rechargeable battery as recited in claim 15, wherein the orthophosphate anode further comprises a form of carbon.

17. The rechargeable battery as recited in claim 16, wherein the form of carbon in the orthophosphate anode comprises at least one form of carbon selected from the group consisting of carbon nanotubes, graphene, and graphene oxide.

18. The rechargeable battery as recited in claim 17, wherein the orthophosphate cathode further comprises a form of carbon.

19. The rechargeable battery as recited in claim 18, wherein the form of carbon in the orthophosphate cathode comprises at least one form of carbon selected from the group consisting of carbon nanotubes, graphene, and graphene oxide.
